(19) United States
(12) Patent Application Publication
(10) Pub. No.: US 2025/0375984 A1
(43) Pub. Date: Dec. 11, 2025

(54) NON-PNEUMATIC TIRE

(71) Applicant: The Goodyear Tire & Rubber Company, Akron, OH (US)

(72) Inventor: Daniel Paul Luc Marie Hinque, Colmar-Berg (LU)

(21) Appl. No.: 18/739,640

(22) Filed: Jun. 11, 2024

(51) Int. Cl. B60C 7/18

(52) U.S. Cl. CPC B60C 7/18

(57) ABSTRACT

The invention is directed to a non-pneumatic tire with a supporting structure comprising a radially inner annular portion, a radially outer annular portion, and a plurality of spokes extending between these portions along a circumferential direction of the tire. In one aspect, two circumferentially neighboring spokes are interconnected by a winding comprising a cord wound in multiple loops through the neighboring spokes, and the radially inner annular portion comprises circumferentially extending cords. In some aspects, the spokes have, from spoke to spoke, alternating angles with the axial direction along a circumferential direction of the tire. In another aspect, said radially inner annular portion comprises one or more of axially extending recesses and protrusions on a radially inner surface of the radially inner annular portion. Furthermore, the present invention is directed to a tire rim assembly comprising such a non-pneumatic tire and a corresponding rim.

### FIELD OF THE INVENTION

The present invention is directed to a non-pneumatic tire and to a tire rim assembly comprising a non-pneumatic tire and a rim.

### BACKGROUND OF THE INVENTION

A plurality of different concepts for modern non-pneumatic tires has been suggested in the prior art. While non-pneumatic tires do not need inflation pressure and are typically more puncture resistant than conventional pneumatic tires, it can still be a challenge to efficiently build such non-pneumatic tires in mass production at reasonable costs. Furthermore, various tire components and/or their interfaces shall be robust and durable. While continuous developments have been made in this field over the past years, significant room for improvement remains.

### SUMMARY OF THE INVENTION

In a first aspect, the present invention is directed to a non-pneumatic tire comprising a supporting structure comprising a radially inner annular portion, a radially outer annular portion, and a plurality of spokes extending between the radially inner annular portion and the radially outer annular portion along a circumferential direction of the tire. Two circumferentially neighboring spokes of the plurality of spokes are interconnected by a winding comprising a cord wound in multiple loops along a lateral width of the tire. In addition, the radially inner annular portion comprises a plurality of circumferentially extending cords provided radially inwards the winding. Still in accordance with the first aspect, the spokes have, from spoke to spoke, alternating angles with the axial direction along a circumferential direction of the tire.

In a second aspect, the present invention is directed to a non-pneumatic tire comprising a supporting structure comprising a radially inner annular portion, a radially outer annular portion, and a plurality of spokes extending between the radially inner annular portion and the radially outer annular portion along a circumferential direction of the tire, wherein the radially inner annular portion has, along the circumferential direction, one or more of axially extending recesses and protrusions on its radially inner surface.

In a third aspect, the present invention is directed to a non-pneumatic tire comprising a supporting structure comprising a radially inner annular portion, a radially outer annular portion, and a plurality of spokes extending between the radially inner annular portion and the radially outer annular portion along a circumferential direction of the tire. Each of the radially inner annular portion, the radially outer annular portion, and the plurality of spokes comprise one or more elastomer compositions, wherein the one or more elastomer compositions of the radially inner annular portion, the radially outer annular portion, and the plurality of spokes are reinforced by cords, and wherein each of the spokes laterally extends, along its entire radial height, over at least 40% of the maximum axial width of the tire. Still in accordance with the third aspect, the spokes have, from spoke to spoke, alternating angles with the axial direction of the tire along a circumferential direction of the tire.

In a fourth aspect, the present invention is directed to a non-pneumatic tire comprising a supporting structure comprising a radially inner annular portion, a radially outer annular portion and a plurality of spokes extending between the radially inner annular portion and the radially outer annular portion along a circumferential direction of the tire. Still according to the fourth aspect, two circumferentially neighboring spokes of the plurality of spokes are interconnected by a winding comprising a cord wound in multiple loops through the two circumferentially neighboring spokes along a lateral width of the tire, and the radially inner annular portion comprises a plurality of circumferentially extending cords provided radially inwards the winding, and wherein the radially inner annular portion conically tapers from each lateral side of the tire towards an axial center of the tire.

### BRIEF DESCRIPTION OF THE DRAWINGS

The invention will be described by way of example and with reference to the accompanying drawings in which:

FIG. 1 is a schematic perspective view of a non-pneumatic tire in accordance with an embodiment of the present invention;

FIG. 2 is a schematic side view of the non-pneumatic tire already shown in FIG. 1;

FIG. 3 is a partial schematic cut view of the non-pneumatic tire already shown in FIG. 1 and in FIG. 2;

FIG. 4 is a schematic side view of a circumferential portion of the supporting structure of the tire shown in FIGS. 1 and 2;

FIG. 5 is a schematic perspective view of two windings for interconnecting three circumferentially neighboring spokes, such as shown in FIGS. 1 to 4;

FIG. 6 is a schematic cut view of the supporting structure shown in FIG. 4;

FIG. 7 is a schematic perspective view of a tire rim assembly according to an embodiment of the present invention, which comprises the non-pneumatic tire shown in FIGS. 1 and 2 mounted to a corresponding rim;

FIG. 8 is a schematic perspective view of the rim of the tire rim assembly shown in FIG. 7;

FIG. 9 is a schematic perspective view of a biconical rim, in accordance with another embodiment of the present invention;

FIG. 10 is a schematic perspective view of another embodiment of a non-pneumatic tire in accordance with the present invention, comprising an axially split radially inner base band portion;

FIG. 11 is a partial schematic cut view of the non-pneumatic tire already shown in FIG. 10; and

FIG. 12 is a schematic perspective view of a tire rim assembly in accordance with another embodiment of the present invention.

### DETAILED DESCRIPTION OF THE INVENTION

According to the first aspect, the non-pneumatic tire comprises a supporting structure comprising a radially inner annular portion, a radially outer annular portion, and a plurality of spokes extending between the radially inner annular portion and the radially outer annular portion along a circumferential direction of the tire. Two circumferentially neighboring spokes (in other words, each or every two circumferentially neighboring or adjacent spokes) of the plurality of spokes are interconnected by a winding comprising a cord (or, in other words, a winding of a cord) wound in multiple loops through the two circumferentially neighboring spokes along a (lateral) width of the tire. Furthermore, the radially inner annular portion comprises a plurality of circumferentially extending cords provided radially inwards the winding. The spokes have, from spoke to spoke along a circumferential direction of the tire, alternating angles with the axial direction.

Such a non-pneumatic tire is robust and durable. In particular, neighboring spokes being reinforced by a common winding provide additional robustness and durability to the supporting structure. In addition, the inner annular portion comprising a cord reinforcement extending along the circumferential direction also provides further stability to the supporting structure as such, and provides a robust interface with a radially outer surface of a rim. Furthermore, the spokes having alternating angles with the axial direction of the tire can help to provide further stiffness to the tire, particularly with regards to cornering maneuvers. Another benefit of such alternating angles consists in easier manufacturing, such as easier demolding of molding inserts for making such spokes and/or the supporting structure of the tire.

In one embodiment, every second spoke of the plurality of spokes has an angle of at least 0.1° with the axial direction of the tire, and every first spoke (or spoke neighboring every second spoke) of the plurality of spokes has an angle of one or more of i) 0° with the axial direction of the tire and ii) at least 0.1°, optionally having an opposite orientation with the axial direction than the angle of the second spoke.

In another embodiment, each spoke of the plurality of spokes extends along the lateral width of the tire. The lateral width, or just width, of the tire can be considered as being transverse to a radial direction and circumferential direction of the tire, or, in other words to an equatorial plane of the tire.

In another embodiment, the angle of every second spoke is within a range of 0.2° to 10° and the angle of every first spoke (or, in other words, spoke neighboring every second spoke) is within a range of 0.2° to 10°, having an opposite orientation with the axial direction than the angle of every second spoke.

In still another embodiment, the spokes laterally extend (along their entire radial heights) over at least 40% of the maximum axial width of the tire, preferably each spoke extends over at least 70% of the maximum axial width of the tire.

In still another embodiment, multiple circumferential rows of spokes are arranged axially beside one another, e.g., two of such rows.

In still another embodiment, each spoke has an essentially linear cross-sectional shape (in a plane parallel to the equatorial plane of the tire, or perpendicular to the axial direction). Preferably, each spoke has a cross-sectional shape of a curved line, wherein optionally a radial center portion of the spoke is at a circumferential position shifted with respect to the circumferential positions of a radially inner foot portion of the spoke and a radially outer head portion of the spoke. Such a bent shape of the spokes helps to allow a defined bending of the spokes and/or a bending in the same circumferential direction when the tire is loaded, such as under vehicle load.

In still another embodiment, each spoke of the plurality of spokes has a shape of a, preferably bent, sheet extending from the radially outer annular portion to the radially inner annular portion and/or transversely to an equatorial plane of the tire.

In still another embodiment, each spoke has a circumferential thickness within a range of 2 mm to 15 mm, preferably over at least 70% of its radial height.

In still another embodiment, the spokes have, along the circumferential direction of the tire, angles of alternating orientation between ranges of 0.2° to 2° and −0.2° to −2° with the axial direction of the tire, and wherein each spoke of the spokes optionally laterally extends (along its entire radial height) at least over 40% of the maximum axial width of the tire, preferably over at least 70% of the maximum axial width of the tire.

In still another embodiment, the winding extends through the two circumferentially neighboring spokes and a circumferential section of the radially inner annular portion and a circumferential section of the radially outer annular portion. The circumferential sections extend circumferentially between the two circumferentially neighboring spokes. Thus, the winding interconnects both of the neighboring spokes, the inner annular portion, and the outer annular portion. The wording of extending between a first feature and a second feature shall also include extending from a first feature to a second feature in the present aspects and their embodiments.

In still another embodiment, said two circumferentially neighboring spokes of the plurality of spokes comprise a first neighboring spoke and a second neighboring spoke which are interconnected by a first winding of a cord wound in multiple loops through the two circumferentially neighboring spokes along the lateral (or axial) width of the tire. Optionally, a third spoke, of the plurality of spokes, circumferentially neighboring the second neighboring spoke circumferentially opposite to the first neighboring spoke, is interconnected with the second neighboring spoke by a second winding of another cord which is wound in multiple loops through the third spoke and the second neighboring spoke along a lateral width of the tire.

In still another embodiment, the first winding and the second winding interdigitate with one another along the lateral width of the second neighboring spoke.

In still another embodiment, the first winding and the second winding interdigitate at least over a portion of their length and/or radial height in the same plane.

In still another embodiment, the plane has one of the alternating angles with the axial direction.

In still another embodiment, the first winding and the second winding have one or more of: a winding pitch within a range of 0.5 mm to 5 mm; opposite winding directions chosen from a lefthanded winding direction and a righthanded winding direction; a shape bent in the same orientation with respect to the circumferential direction of the tire; and essentially equal winding pitches.

In still another embodiment, the radially inner annular portion comprises an annular spoke connecting portion integrally formed with radially inner ends (or foot portions) of the plurality of spokes. Preferably, the spokes and one or more of the annular portions, comprise an elastomer composition, such as a rubber composition.

In still another embodiment, the annular spoke connecting portion comprises the circumferentially extending cords.

In still another embodiment, the radially inner annular portion comprises the annular spoke connecting portion and an annular base band portion (or base band portion) arranged radially inwards the annular spoke connecting portion.

In still another embodiment, the annular spoke connecting portion comprises a radially inner portion of each winding, and optionally, radially below the radially inner portion of the winding, the circumferentially extending cords. The radially inner portion of the winding can also be described as radially inner and/or circumferentially extending section of the winding.

In still another embodiment, the annular base band portion comprises the circumferentially extending cords. Such an embodiment may be preferred for mass production and/or easy assembly. The annular base band portion preferably comprises an elastomer composition, such as a rubber composition, reinforced by the circumferentially extending cords.

In still another embodiment, each of the radially inner annular portion (such as including the annular spoke connecting portion and/or the annular base band portion), the radially outer annular portion, and the plurality of spokes comprise one or more elastomer compositions.

In still another embodiment, the one or more elastomer compositions are rubber compositions, such as a sulfur curable or sulfur cured rubber compositions.

In another preferred embodiment, an elastomer composition (such as a rubber composition) comprises one or more of rubber (such as comprising one or more of natural rubber, synthetic polyisoprene, butadiene rubber, styrene-butadiene rubber, and butyl rubber), a filler (such as comprising one or more of carbon black and silica), resin (such as a hydrocarbon resin selected from one or more of coumarone-indene resins, petroleum hydrocarbon resins, terpene resins, styrene/alphamethylstyrene resins, terpene phenol resins, rosin derived resins and copolymers and/or mixtures thereof), accelerators, antidegradants, oils, liquid diene-based polymers, coupling agents (such as carbon black coupling agents and/or silanes), sulfur donors, and sulfur. Liquid means herein that a material is in a liquid state at 23° C. Optionally, elastomer compositions, such as rubber compositions, may be fiber reinforced.

In still another embodiment, the elastomer composition, or rubber composition, comprises 100 phr of rubber comprising one or more of natural rubber, synthetic polyisoprene, polybutadiene rubber, and styrene butadiene rubber. In the supporting structure, such a composition preferably comprises at least 50 phr of natural rubber (such as from 50 phr to 100 phr of natural rubber, and optionally from 0 phr to 50 phr of polybutadiene rubber). Additionally, the elastomer or rubber composition comprises a filler, preferably comprising carbon black and/or silica. For instance, such filler may be within a range of 20 phr to 150 phr, preferably within a range of 30 phr to 90 phr. Preferably, such a filler comprises predominantly carbon black. The elastomer or rubber composition may further comprise from 1 phr to 40 phr of resin, preferably including a phenolic resin. Moreover, the elastomer or rubber composition may comprise from 1 phr to 30 phr of oil, preferably from 1 phr to 20 phr of oil. Finally, the elastomer or rubber composition may typically comprise from 1 phr to 15 phr of antidegradant(s), from 0.5 phr to 10 phr of accelerator(s), from 0.1 phr to 10 phr of zinc oxide, and from 0.5 phr to 10 phr of sulfur. Further ingredients may also be present.

In still another embodiment, the spokes are cord and/or fiber-reinforced, wherein one or more cords (such as cords of the winding and/or the circumferential cords) and/or fibers optionally comprise one of textile, carbon, metal, bio-based, polymer, and glass fiber material.

In still another embodiment, cords and/or fibers comprise a textile material, optionally selected from one or more of polyester (preferably, PET), polyamide (preferably, one or more of PA-6, PA-6,6, e.g., Nylon™, aromatic polyamide/aramid), and rayon. Optionally, one or more of these materials may be recycled materials. Using hybrid materials or cords and/or fibers of multiple such materials is also an option.

In another embodiment, cords provided herein are one or more of single filament cords and multifilament cords. For instance, cords may have (maximum) diameters measured perpendicularly to the extension of the cord within a range of 0.01 mm to 2 mm, preferably within a range of 0.01 mm and 1 mm, measured after extraction of the cord from the tire.

In still another embodiment, multiple components, members, and/or portions mentioned herein may be adhered, cured, and/or co-cured to one another. For instance, it is possible to attach multiple components, members, and/or portions comprising uncured, precured, and/or cured elastomer or rubber compositions together and cure or co-cure them. Preferably, they are sulfur cured to each other. Peroxide cure is another option. Additionally, or alternatively, uncured rubber, primers or dips (such as RFL-based) and/or adhesives can be used to improve connection between such components, members, and/or portions. Suitable adhesives are also commercially available and known to the person skilled in the art. They can be chosen in view of the compositions to be attached to each other. For instance, adhesives include one or more of rubber based, silicone based, isocyanate based, acrylate based, epoxide based, polyurethane based adhesives.

For instance, at least two of the shearband, the tread portion, the supporting structure (such as including the radially outer annular band portion, the spokes, the radially inner band portion, and optionally the spoke connecting portion and the annular base band portion) could be cured or co-cured to one another. Preferably, they are assembled in an uncured state and cured together, such as by sulfur cure. Optionally, one or more of these components, members, and/or portions could be precured before. Alternatively, one or more components, members, and/or portions could be cured and co-cured later with other components, members, and/or portions.

Optionally, a curing cement, such as used for retreading tires, can be used to co-cure elastomer composition portions to already cured elastomer composition portions. The use of a green rubber layer is also possible for co-curing. Optionally, one or more functional polymers may be used in one or more of the elastomer compositions and which support co-curing. Such functional groups may comprise but are not limited to one or more of isocyanate, hydroxide, halogenide, amine, amide, carboxylic, epoxide, acrylate, peroxide, and other suitable groups.

In still another embodiment, the one or more elastomer compositions of the radially inner annular portion (such as its circumferential spoke connecting portion), the radially outer annular portion, and two circumferentially neighboring spokes of the plurality of spokes are reinforced and interconnected by said winding.

In still another embodiment, the radially inner annular portion (such as its radially inner annular base band portion) is reinforced by the plurality of circumferentially extending cords.

In still another embodiment, one or more of the radially inner annular portion, the radially outer annular portion, the annular spoke connecting portion, the annular base band portion, and the spokes comprise one or more elastomer compositions. The cords may extend through and/or reinforce the respective elastomer composition.

In still another embodiment, the tire comprises a circumferential tread band arranged on a radially outer side of the radially outer annular portion of the supporting structure. The tread band optionally comprises a radially outer circumferential tread portion and a circumferential shearband arranged radially between the tread portion and the radially outer annular portion of the supporting structure.

According to the second aspect, the non-pneumatic tire comprises a supporting structure comprising a radially inner annular portion, a radially outer annular portion, and a plurality of spokes extending between the radially inner annular portion and the radially outer annular portion along a circumferential direction of the tire. The radially inner annular portion has along the circumferential direction one or more of axially extending recesses and protrusions on its radially inner surface.

Such axially extending recesses and/or protrusions can be used to anchor the tire to a rim, such as for avoiding or reducing relative circumferential slip with respect to the rim. For instance, the resulting mechanical interlocking between the tire and the rim can be sufficient, without requiring adhesives applied at the interface between rim and tire.

In one embodiment, the one or more of axially extending recesses and protrusions have one or more of an axial extension of at most 80% of the maximum axial width of the tire, an axial extension of at least 5% of the maximum axial width of the tire; a radial height (or in other words depth) from 10% to 60% of the radial thickness of the radially inner annular portion (wherein the radial thickness of the radially inner annular portion is measured between two adjacent spokes and circumferentially beside a recess or protrusion); a maximum circumferential width within a range of 5 mm and 5 cm; and an axially inwards tapering shape.

In another embodiment, the axially extending recesses are axially extending slots, optionally tapering in an axially inner direction. In particular, the axially inner direction and axially outer direction refer to an axial center of the tire. Alternatively, they can be understood as axially inwards and axially outwards, respectively.

In still another embodiment, the tire comprises from 10 to 50 of the one or more of axially extending recesses and protrusions. Preferably, the tire comprises from 5 to 20 of the one or more of axially extending recesses and protrusions on each lateral side of the tire.

In still another embodiment, the protrusions are axially extending ribs, optionally tapering in an axially inner direction. However, the protrusions can also be radially extending posts or knobs, e.g., arranged and adapted to axially slide into axially extending recesses or slots in a radially outer surface of a corresponding rim.

In another embodiment, the one or more of axially extending recesses and protrusions extend axially from at least one lateral (face) side of the tire, such as towards a laterally opposite (face) side of the tire, and optionally towards an equatorial plane of the tire.

In another embodiment, the invention is directed to a tire rim assembly comprising the tire, wherein the radially inner annular portion circumferentially surrounds a hollow space, such as an essentially cylindrical hollow space or a biconical hollow space; and a rim insertable into the hollow space, wherein the rim comprises one or more of axially extending protrusions and recesses, preferably complementary to one or more of the axially extending recesses and protrusions of the tire for locking the tire against movement in the circumferential direction relative to the rim when the rim is inserted into the hollow space.

In an embodiment, the rim comprises, on at least one of its lateral sides, a flange portion blocking movement of the radially inner annular portion in an outer axial direction.

In another embodiment, the rim comprises two laterally or axially opposite and circumferential flange portions, wherein at least one of the flange portions is (detachably) mountable with respect to another one of the flange portions to hold the tire between both flange portions against relative movement of the tire and the rim in an axial direction.

In still another embodiment, the rim comprises one or more of two laterally neighboring circumferential rim members axially insertable from two opposite lateral sides of the tire into said hollow space; two laterally opposite circumferential flange portions; and a radially inner hub portion with circumferentially arranged mounting holes for receiving one or more of bolts and screws for mounting the rim to a vehicle.

In still another embodiment, the radially inner annular portion comprises axially extending and tapering recesses and the rim has axially extending and tapering protrusions which are axially insertable into the axially extending and tapering recesses of the inner annular portion.

In still another embodiment, the rim comprises a drum portion having a radially outer surface (such as an essentially cylindrical radially outer surface, or a biconical radially outer surface) and two annular flange portions removably attachable to at least one, preferably to each lateral side of the drum portion, wherein optionally each flange portion comprises the axially extending and tapering protrusions, which are provided or arranged on the radially outer surface of the drum portion upon attachment of the flange portion(s) to the drum portion.

In still another embodiment, the rim comprises a drum portion having a radially outer surface, wherein the drum portion comprises two axially adjacent drum portion members, and wherein, optionally, each of the two drum portion members comprises at one of its (axially outer) face sides one of the flange portions, and wherein each of the drum portion members is axially insertable into the hollow space of the tire from one lateral side of the tire and wherein both drum portion members are preferably axially connectable to each other to hold the tire on the rim. In addition, or alternatively, each drum portion member conically tapers from one lateral side of the drum portion towards an equatorial plane of the tire (when the rim is mounted to the tire, or vice versa).

According to the third aspect, the present invention is directed to a non-pneumatic tire comprising a supporting structure comprising a radially inner annular portion, a radially outer annular portion, and a plurality of spokes extending between the radially inner annular portion and the radially outer annular portion along a circumferential direction of the tire. Each of the radially inner annular portion, the radially outer annular portion, and the plurality of spokes comprises one or more elastomer compositions, wherein the one or more elastomer compositions of the radially inner annular portion, the radially outer annular portion, and the plurality of spokes are reinforced by cords, and wherein each of the spokes laterally extends along its entire radial height over at least 40% (preferably, over at least 70%, or even more preferably, over at least 80%) of the maximum axial width of the tire. Still in accordance with the third aspect, the spokes have, from spoke to spoke, alternating angles with the axial direction along a circumferential direction of the tire.

As mentioned already above, such a tire and/or spoke design helps to provide an even more robust tire, which particularly has a high stiffness in cornering maneuvers compared to merely axially extending spokes, or spokes extending without alternating angles. Also demolding of such a tire can be improved.

According to the fourth aspect, the present invention is directed to a non-pneumatic tire comprising a supporting structure comprising a radially inner annular portion, a radially outer annular portion and a plurality of spokes extending between the radially inner annular portion and the radially outer annular portion along a circumferential direction of the tire. Two, or every two, circumferentially neighboring spokes of the plurality of spokes are interconnected by a winding comprising a cord wound in multiple loops through the two circumferentially neighboring spokes along a lateral width of the tire, wherein the radially inner annular portion comprises a plurality of circumferentially extending cords provided radially inwards the winding, and wherein the radially inner annular portion conically (and/or a radially inner surface of the radially inner annular portion) tapers from each lateral side of the tire towards an axial center of the tire, or in other words an equatorial plane of the tire.

Such an embodiment provides an improved connection between the tire and rim.

In one embodiment, the radially inner annular portion comprises one or more of i) an annular connecting portion integrally formed with radially inner ends of the plurality of spokes and comprising radially inner portions of the winding, and ii) an annular (base) band portion arranged radially inwards the connecting portion which comprises the plurality of circumferentially extending cords, wherein the annular band portion conically tapers from each lateral side of the tire towards the axial center of the tire, or the equatorial plane of the tire.

In another embodiment, a radially inner surface of the inner annular portion (preferably, the annular band portion) tapers from each lateral side of the tire with an angle within a range of 0.5° to 10°, preferably of 1° to 6°, with the axial direction of the tire.

In still another embodiment, the radially inner annular portion (e.g., the annular band portion) has along the circumferential direction one or more of axially extending recesses and protrusions on its radially inner surface.

In still another embodiment, the radially inner surface is flat.

In still another embodiment, the invention is directed to a tire rim assembly comprising the non-pneumatic tire according to the fourth aspect (and, optionally, in accordance with one or more of its embodiments), wherein the radially inner annular portion circumferentially surrounds a preferably essentially biconical hollow space; and a split/two-piece rim comprising a first rim member comprising a first conical drum portion and a second rim member comprising a second conical drum portion. Optionally, the first conical drum portion is insertable from a first lateral side of the tire into the biconical hollow space so as to contact the conically tapering inner band portion, and the second conical drum portion is insertable from a second lateral side of the tire into the biconical hollow space so as to contact the conically tapering band portion.

In another embodiment, the split rim comprises one or more of axially extending protrusions and recesses complementary to one or more of axially extending recesses and protrusions of and/or in the tire to lock the tire against movement in the circumferential direction relative to the rim when the rim is inserted into the hollow space, or, in other words, when the tire is mounted to the rim.

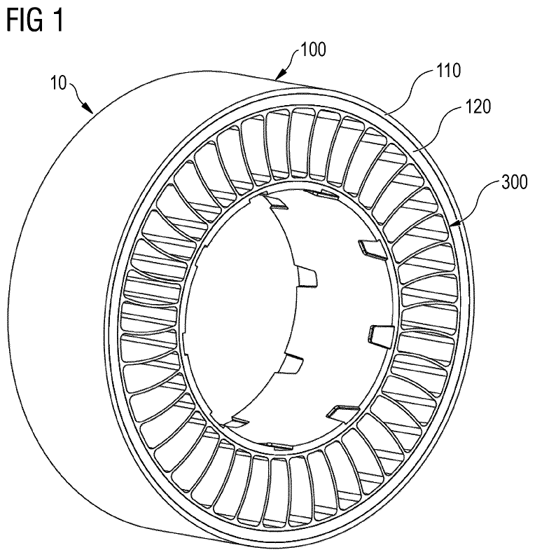

FIG. 1 shows a perspective view of the non-pneumatic tire 10 in accordance with an embodiment of the present invention. The tire 10 comprises a supporting structure 300 which extends along the circumferential direction of the tire 10 and supports a radially outer tread band 100 which extends along the circumferential direction of the tire 10. In particular, the tread band 100 comprises a radially outer tread portion 110 which is supported by a circumferential shearband 120 arranged radially between the circumferential tread portion 110 and the circumferential supporting structure 300. The supporting structure 300 comprises a plurality of cord-reinforced rubber composition spokes provided along the circumferential direction of the tire 10.

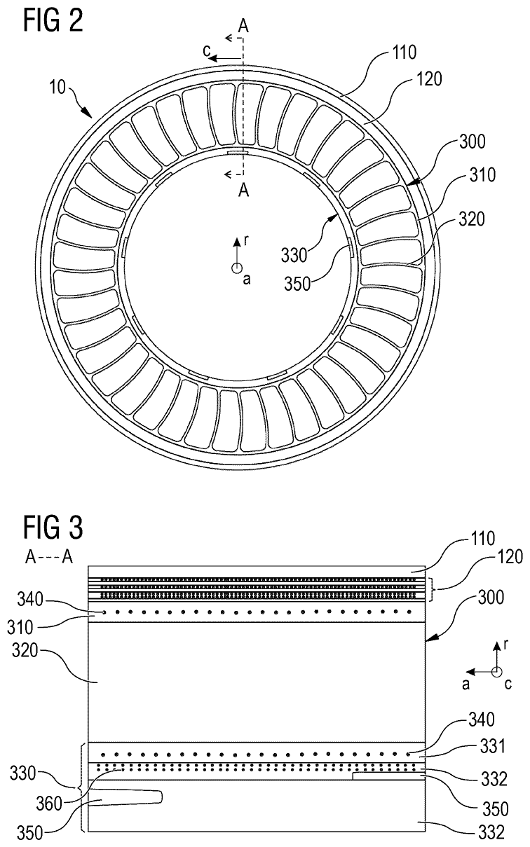

FIG. 2 is a side view of the tire 10 already shown in FIG. 1, using the same reference signs where appropriate. Thus, the depicted tire 10 comprises the supporting structure 300, a circumferential shearband 120, and a radially outermost circumferential tread portion 110. The supporting structure 300 comprises a radially outer annular portion 310 and a radially inner annular portion 330, wherein the plurality of spokes 320 extends radially between the radially outer annular portion 310 and the radially inner annular portion 330 so as to support the radially outer annular portion 310 on the radially inner annular portion 330. It is noted that the radially inner annular portion 330 may comprise one or more circumferential layers or bands as described further herein below. In a radially inner surface, the radially inner annular portion 330 comprises multiple axially extending recesses 350 usable for connecting the tire 10 with a suitable rim (not shown in FIG. 2) against relative tire rim slip along the circumferential direction of the tire 10. While the present embodiment has axially extending recesses 350, other embodiments may be devoid of such recesses. In such cases, the friction of a radially inner surface of the radially inner annular portion may serve to avoid relative circumferential slip between the non-pneumatic tire and its rim.

For the sake of better intelligibility, the axial direction a, the radial direction r, and the circumferential direction c are indicated in FIG. 2, and also in other Figures herein, where appropriate. The axial direction a is parallel to the axis of rotation of the tire 10, the radial direction r is perpendicular to the axial direction a, and the circumferential direction c, is perpendicular to the axial direction a and the radial direction r. The circumferential direction c is parallel to a circumferential centerline of the tire and/or to an equatorial plane of the tire. Such directions are not necessarily limited to a specific orientation, unless indicated otherwise herein.

FIG. 3 is a more detailed, but still schematic, cut view of the tire 10 already shown in the previously mentioned FIGS. 1 and 2, along the plane A-A as indicated in FIG. 2. With reference to FIG. 3, the schematically depicted tread portion 110 is carried by the shearband 120. While not explicitly shown herein, the tread portion 110 may comprise a plurality of tread grooves, such as circumferential tread grooves and/or lateral tread grooves. It may also comprise a plurality of circumferential tread layers, such as a base tread, and one or more tread cap layers. Such layers may comprise one or more rubber compositions. It is also possible that the tread portion 110 has a larger radial thickness than shown herein. In the present embodiment, the shearband 120 comprises six circumferentially extending and radially stacked layers, wherein some of those are reinforced by cords. Shearbands as such, having multiple stacked layers, are known in the art of non-pneumatic tires and are not within the main focus of the present invention. For example, optionally, a shearband has from 4 to 20 elastomer composition layers, typically comprising multiple non-cord reinforced rubber composition layers and multiple cord reinforced rubber composition layers. For instance, cord reinforced rubber composition layers may comprise textile cords and/or metal cords, such as steel cords, as known in the art. Elastomer compositions, such as rubber compositions, which are also known in the art, may be adapted in accordance with the desired application and/or performance of the tire.

Referring again to FIG. 3, the radially outer annular portion 310 (which could also be described as radially outer connecting portion) and the radially inner annular portion 330 are radially interconnected by the spoke(s) 320 of the supporting structure 300. In particular, two circumferentially neighboring spokes are connected by an axially extending winding 340 comprising at least one cord wound along a lateral width direction through two circumferentially neighboring spokes, as only partially visible in the cut view of FIG. 3 but further indicated in FIGS. 5 and 6. The radially inner annular portion 330 comprises, in the present non-limiting embodiment, i) the annular spoke connecting portion 331 connecting radially inner ends of the plurality of spokes, and ii) a radially inner annular base band portion 332 comprising a circumferentially arranged cord-reinforcement. In other words, the radially inner annular base band portion 332 comprises a plurality of circumferentially extending cords 360.

Furthermore, the annular base band portion 332 of the radially inner annular portion 330 comprises axially extending recesses 350 on (or in) a radially inner (most) surface of the annular base band portion 332. In the present embodiment, these axially extending recesses 350 extend from one of the lateral sides of the supporting structure 300 of the tire. Optionally, such a recess 350 extends over at least 10% of the total axial width of the tire, preferably having an axial width within a range of 10% to 50% of the total axial width of the tire. Preferably, multiple recesses 350 are circumferentially spaced from one another along the circumference of the tire. Moreover, preferably, such recesses 350 are arranged on each axial side of tire. In other words, the recesses 350 extend from one lateral outer side of the tire in an axial direction towards an axial center or equatorial plane of the tire. Preferably, the recesses do not extend over the whole axial width of the annular base band portion 332 which is advantageous for tire robustness and/or durability, and for an efficient rim mounting.

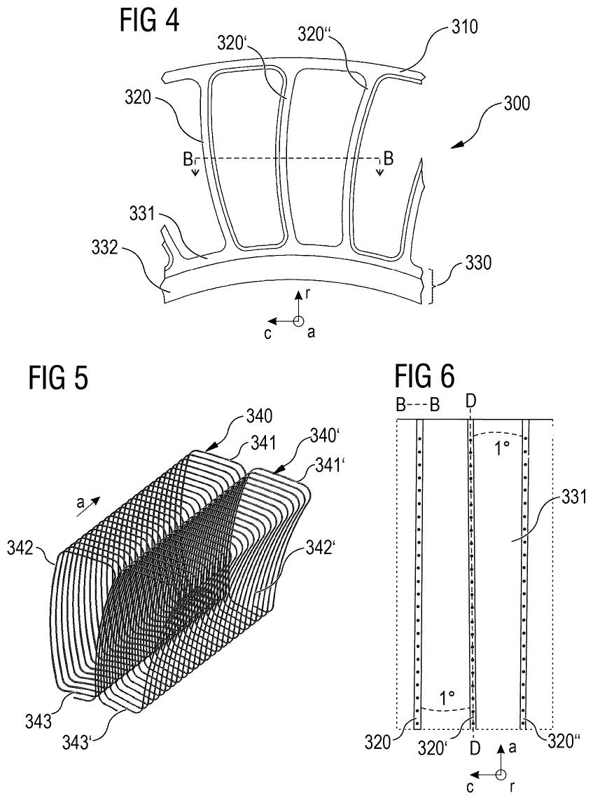

FIG. 4 shows a partial side view of the supporting structure 300 comprising the radially outer annular portion 310, multiple spokes 320, 320′, 320″, and the radially inner annular portion 330, comprising the annular spoke connecting portion 331 and the annular base band portion 332 arranged radially inwards the annular spoke connection portion 331. In other embodiments, the annular spoke connecting portion and the annular base band portion may be integrally formed to provide the radially inner annular portion. In particular, as visible in the magnified view according to FIG. 4, every second spoke of the circumferential row of spokes has a different angle with the axial direction along its lateral extension through the tire than every first and/or neighboring spoke. In other words, the extension of the spokes, such as the spokes 320, 320′, 320″, has alternating angles with the axial direction a, along the circumferential direction c of the tire, or the supporting structure 300, respectively. Such alternating angles are also visible in the cut view B-B of FIG. 4 as shown in FIG. 6.

As visible in FIG. 6, the laterally extending spokes 320, 320′, 320″ have alternating angles with the axial direction a. In particular, a total angle between spokes 320 and 320′ is 1°. A first angle of the first spoke 320 with the axial direction a is 0.5° and a second angle of the second spoke 320′ with the axial direction is 0.5° but with an opposite orientation than the first angle of the first spoke 320. The third spoke 320″, circumferentially neighboring the second spoke 320′ (on a circumferentially opposite side than the first spoke 320), has again an angle of 0.5° with the axial direction as the first spoke 320. In the present example, the angles with the axial direction are relatively small but may be larger in other embodiments. For instance, angles with the axial direction may be within a range of 0.1° to 10°, preferably within a range of 0.2° to 5°. As further indicated in FIG. 6, each spoke 320, 320′, 320″ extends over almost the whole axial width of the tire, or of the supporting structure, or of the spoke connecting structure 331 respectively. Typically, each spoke extends over at least 40% of the total axial width of the tire, or over at least 70% of the total axial width of the tire. As also shown in FIG. 6, each spoke 320′, 320″, 320″ comprises cords which extend essentially radially through the spokes 320′, 320″, 320″. In particular, these cords are essentially radially extending portions of axially extending windings running through circumferentially neighboring spokes.

In this context, FIG. 5 shows two windings 340, 340′ comprising cords wound along a lateral width of the tire. These two windings 340, 340′ correspond to windings connecting three spokes, such as spokes 320, 320′, 320″ of FIG. 6. In particular, the windings 340, 340′ comprise radially outer portions 341, 341′ and radially inner portions 343, 343′, which essentially extend in the circumferential direction, and radial portions 342, 342′, which extend essentially along the radial direction (including cases in which the cords and the spokes are (e.g., slightly) bent in the circumferential direction along the radial direction, as shown in FIGS. 4 and 5). As shown in FIG. 5, two circumferentially neighboring windings 340, 340′ preferably interdigitate with each other, e.g., at about half of their winding pitch. In other words, they interdigitate in essentially the same (bent) plane D-D over at least a portion of their radial height, such as also visible in the spoke 320′ of FIG. 6.

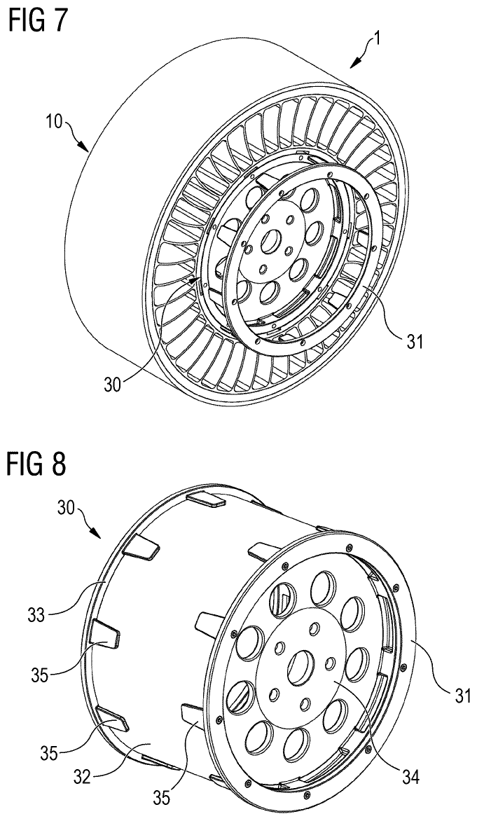

FIG. 7 shows a tire rim assembly 1 in accordance with an embodiment of the present invention. The tire rim assembly 1 comprises the non-pneumatic tire 10 (which is also shown in FIGS. 1 and 2) and the rim 30. In the present embodiment, the rim 30 comprises an axially mountable rim flange 31 which is shown herein in a demounted position. In particular, the rim 30 is insertable into the hollow cylindrical space surrounded by a radially inner surface of the radially inner annular portion of the tire 10. The rim 30 comprises axially extending protrusions for mechanically interlocking with the axially extending recesses in the radially inner annular portion of the tire 10, so as to avoid a relative circumferential movement or slip of the tire 10 mounted to the rim 30.

FIG. 8 illustrates further details of the rim 30 which is shown in FIG. 7. The rim 30 comprises a cylindrical drum portion 32 and two axially outer circumferential flange portions 31 and 33. In the present embodiment of the rim 30, both flange portions 31, 33, having a larger diameter than the drum portion 32, are axially mountable to the drum portion 32. However, in alternative embodiments, one of the flange portions may also be integrally formed with the drum portion and/or permanently fixed to the drum portion of the rim. A fixation of the circumferential flange portions 31, 33 can, e.g., be carried out by screws in a preferred example. Moreover, the rim 30 comprises on both axial sides protrusions 35 arranged on a radially outer surface of the drum portion upon mounting the flange portions 31, 33 to the drum portion 32. The axially extending protrusions 35 extend in an inner axial direction of the drum portion 32 on the radially outer surface of the drum portion 32. In the present nonlimiting embodiment, the protrusions 35 are integrally formed with the circumferential flange portions 31, 33. Alternatively, those could be integrally formed with or mountable to the drum portion, particularly on at least one lateral side of the rim. Moreover, the protrusions 35 taper along an axially inner direction which simplifies mounting and demounting of the tire. For instance, a tire can be mounted, in a first step, to the central cylindrical drum portion 32 comprising the mounted flange portion 33 including the left hand side protrusions 35 so that the protrusions 35 of the flange portion 33 slide along the axial direction into the corresponding, and/or complementary axial recesses of the corresponding tire. In a further step, the annular flange portion 31 is inserted with its axially extending protrusions into corresponding axially extending recesses of the tire along the radially outer surface of the drum portion 32. After fixation of the flange portion 31 to the drum portion 32, the rim 30 can be mounted, in another step, via a hub portion 34, to a vehicle (not depicted herein). In an embodiment, each lateral, or axial, side of the rim 30 comprises from 5 to 50 axially extending protrusions 35. Axially extending protrusions 35 on one lateral side of the rim 30 are preferably arranged circumferentially between axially extending protrusions 35 on the opposite lateral side of the rim 30. In other words, protrusions 35 on one lateral side of the rim 30, are arranged at circumferentially shifted positions with respect to the circumferential positions of protrusions 35 on the opposite lateral side of the rim 30. Preferably, circumferential distances between protrusions 35 are equal, such as on both lateral sides of the tire. Preferably, their sizes and shapes are also equal, which simplifies assembly of the rim 30 when mounting the tire.

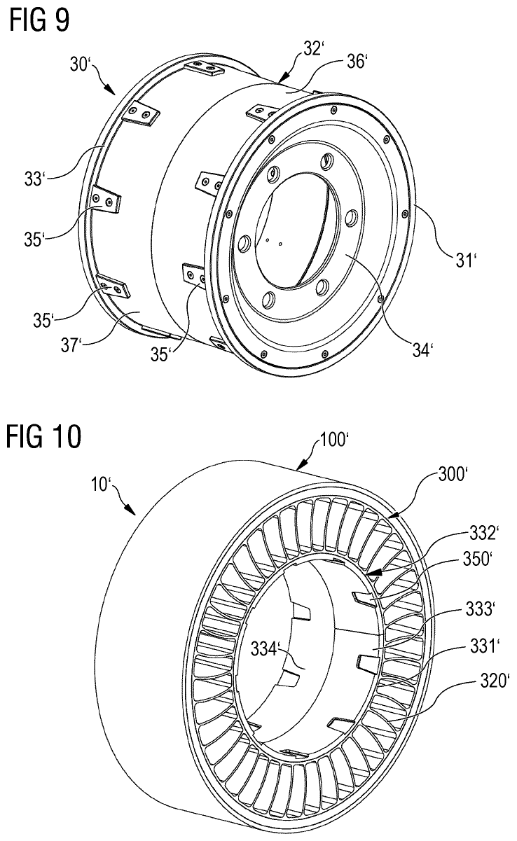

FIG. 9 shows an alternative embodiment of a rim 30′ which has a split drum portion 32′ comprising a first drum portion member 36′ and a second drum portion member 37′, which can be attached to each other in an axial direction. Preferably, each of the drum portion members 36′, 37′ comprises a conical radially outer surface which tapers towards an axial center of the rim 30′. However, in other embodiments, it is possible that the rim has two essentially cylindrical drum portion members, in other words without a biconical radially outer surface. One of the drum portion members 36′ has a hub portion 34′ for attaching the rim 30′ to a vehicle. Furthermore, the rim 30′ has on each axial face side a circumferential flange portion 31′, 33′. The rim 30′ also comprises a plurality of axial protrusions 35′ arranged on the radially outer surfaces of the drum portion members 36′ and 37′. In this embodiment, the protrusions are fixed to the radially outer surfaces of the drum portion members 36′, 37′ via screw connections. Of course, alternative connections would be possible such as one or more of riveting, welding, soldering, gluing, and further suitable methods. The split design of the drum portion 32′, in the form of the two separate drum portion members 36′, 37′, allows an easy mounting of the tire, such as by axially inserting one drum portion member 36′ into the corresponding hollow cylindrical space of the tire. Then, in a further step, the second drum portion member 37′ can be inserted into the hollow cylindrical space of the tire from an axially opposite side, and both drum portion members 36′, 37′ can be fixed to each other, such as via screw connections. Various connection techniques for connecting split rim members and/or attaching annular flange portions are known in the art and can be used herein.

FIG. 10 shows an alternative embodiment of a non-pneumatic tire 10′ comprising a tread band 100′ and a supporting structure 300′ with a plurality of spokes 320′, an inner annular spoke connecting portion 331′, and an axially split annular base band portion 332′. In other words, the annular base band portion 332′ comprises at least two axially neighboring circumferential base band strips 333′, 334′ forming the annular base band portion 332′. Each of the strips 333′, 334′ can have a splice, wherein both splices are preferably provided at different circumferential regions of the tire 10′, or, in other words in different circumferential or angular sectors of the tire 10′. Such an embodiment may further ease manufacturing of the tire and its components, particularly of the inner annular base band portion 332′. However, as already shown herein above, such a split design is not mandatory. As in the embodiment of FIG. 1, the radially inner surface of the annular base band portion 332′ comprises axially extending recesses 350′.

Furthermore, the tire 10′ is suitable for mounting to the rim 30′ shown in FIG. 9. In particular, the tire 10′ further has a biconical base band portion 332′. In other words, the biconical base band portion 332′ surrounds an essentially biconical hollow space, corresponding or complementary to the radially outer shape of the split drum portion 32′ of the rim 30′.

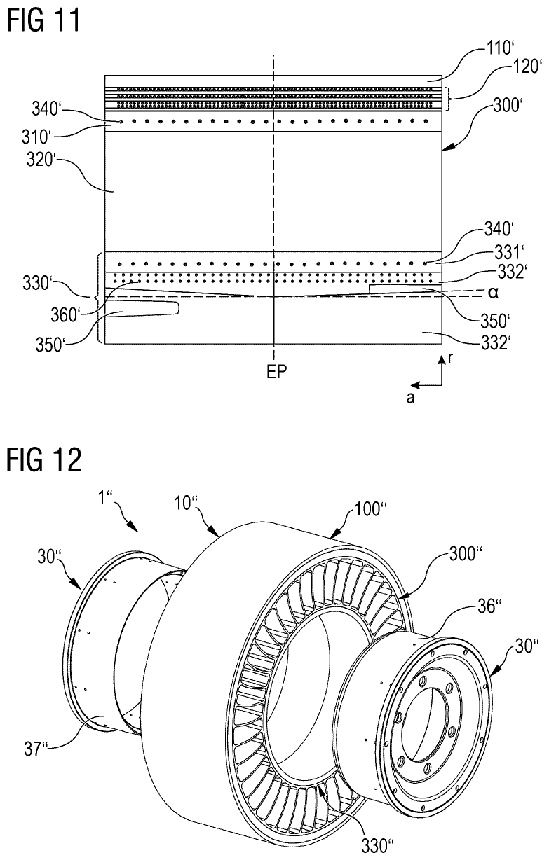

FIG. 11 shows a partial schematic cut view of the tire 10′ shown in FIG. 10. This view is similar to the view already shown in FIG. 3 but shows the biconical shape of the radially inner surface of the base band portion 332′. Thus, the schematically depicted tread portion 110′ is carried by the shearband 120′. The radially outer annular portion 310′ (which could also be described as radially outer connecting portion of the spokes 320′) and the radially inner annular portion 330′ are radially interconnected by the spokes 320′ of the supporting structure 300′. In particular, two circumferentially neighboring spokes 320′ (not explicitly depicted herein) are connected by an axially extending winding 340′ comprising at least one cord wound along a lateral width direction through two circumferentially neighboring spokes 320′. The radially inner annular portion 330′ comprises, in the present non-limiting embodiment, i) the annular spoke connecting portion 331′ connecting radially inner ends of the plurality of spokes 320′, and ii) a radially inner annular base band portion 332′ comprising a circumferentially arranged cord-reinforcement. In other words, the radially inner annular base band portion 332′ comprises a plurality of circumferentially extending cords 360′. Furthermore, the annular base band portion 332′ of the radially inner annular portion 330′ comprises axially extending recesses 350′ on a radially inner (most) surface of the annular base band portion 332′. In alternative embodiments, the annular base band portion 332′ is devoid of such recesses. With respect to the present embodiment, a radially inner surface of the radially inner annular base band portion 332′, or the radially inner annular portion 330′ respectively, has a biconical shape. In particular, this surface tapers from each lateral or axial side of the tire towards the equatorial plane EP with an angle α, which is in the present example about 2°. Such a feature eases mounting and demounting of the tire to a corresponding rim and improves the connection and friction between tire and rim when driving, particularly in cornering maneuvers.

FIG. 12 shows another embodiment of a tire rim assembly 1″ comprising the tire 10″ and a split rim 30″. The tire 10″ comprises a tread band 100″ and a supporting structure 300″ having a radially inner annular portion 330″ which faces a radially outer surface of the rim 30″. In particular, the rim 30″ comprises a first drum portion member 36″ and a second drum portion member 37″ which are axially insertable from two opposite lateral sides of the tire 10″ into a hollow space formed by a radially inner surface of the radially inner annular portion 330″ of the tire 10″. Similar to the embodiment of FIGS. 9 to 11, the radially inner surface of the radially inner annular portion 330″ and the radially outer surface of the axially connectable drum portion members 36″, 37″ have corresponding biconical shapes. In contrast to the previous embodiment, the radially inner annular portion 330″ of the tire 10″ is devoid of axially extending recesses, and the rim 30″ is devoid of complementary axially extending protrusions.

Rims mentioned herein, such as rims 30, 30′, and 30″, may be made of or comprise one or more of polymer compositions, such as thermoplastic polymer compositions, and metal materials. Protrusions and/or recesses in such rims could be manufactured by various techniques. For instance, they may be integrally formed such as by machining or molding, or attached via adhesives, screw connections, riveting, soldering, welding, or other suitable techniques.

The non-pneumatic tire is preferably one of a truck tire, and a passenger car tire. However, also other vehicle types are possible.

It is again emphasized that the features of the first aspect, the second aspect, the third aspect, the fourth aspect, tire and rim assemblies, as well as one or more of their embodiments, can be combined with one another. Embodiments of one aspect are also embodiments of other aspects mentioned herein. Merely for the sake of conciseness such combinations have not been reiterated explicitly in written form.

Variations in the present invention are possible in light of the description of it provided herein. While certain representative embodiments and details have been shown for the purpose of illustrating the subject invention, it will be apparent to those skilled in this art that various changes and modifications can be made therein without departing from the scope of the subject invention. It is, therefore, to be understood that changes can be made in the particular embodiments described which will be within the full intended scope of the invention as defined by the following appended claims.

What is claimed is:

1. A non-pneumatic tire comprising a supporting structure comprising a radially inner annular portion, a radially outer annular portion and a plurality of spokes extending between the radially inner annular portion and the radially outer annular portion along a circumferential direction of the tire,
wherein two circumferentially neighboring spokes of the plurality of spokes are interconnected by a winding comprising a cord wound in multiple loops through the two circumferentially neighboring spokes along a lateral width of the tire; and
wherein the radially inner annular portion comprises a plurality of circumferentially extending cords provided radially inwards the winding; and
wherein the spokes have, from spoke to spoke, alternating angles with the axial direction along a circumferential direction of the tire.

2. The non-pneumatic tire according to claim 1, wherein every second spoke of the plurality of spokes has an angle of at least 0.1° with the axial direction of the tire, and wherein every spoke of the plurality of spokes, neighboring every second spoke, has an angle of one of i) 0° with the axial direction of the tire and ii) at least 0.1° having an opposite orientation with the axial direction than the angle of every second spoke.

3. The non-pneumatic tire according to claim 2, wherein the angle of every second spoke is within a range of 0.2° to 10° and the angle of every spoke neighboring every second spoke is within a range of 0.2° to 10° having an opposite orientation with the axial direction than the angle of every second spoke.

4. The non-pneumatic tire according to claim 1, wherein the spokes laterally extend, along their entire radial height, over at least 40% of the maximum axial width of the tire.

5. The non-pneumatic tire according to claim 1, wherein the spokes have, along the circumferential direction of the tire, angles of alternating orientation between ranges of 0.2° to 2° and −0.2° to −2° with the axial direction of the tire, and wherein each spoke of the plurality of spokes laterally extends, over its entire radial height, at least over 40% of the maximum axial width of the tire.

6. The non-pneumatic tire according to claim 1,
wherein two circumferentially neighboring spokes of the plurality of spokes of the supporting structure comprise a first neighboring spoke and a second neighboring spoke which are interconnected by a first winding of a cord wound in multiple loops through the two circumferentially neighboring spokes along a lateral width of the tire,
wherein a third spoke of the plurality of spokes, circumferentially neighboring the second neighboring spoke circumferentially opposite to the first neighboring spoke, is interconnected with the second neighboring spoke by a second winding of another cord which is wound in multiple loops through the third spoke and the second neighboring spoke along a lateral width of the tire, and
wherein the first winding and the second winding interdigitate with one another along the lateral width of the second neighboring spoke.

7. The non-pneumatic tire according to claim 6, wherein the first winding and the second winding have one or more of:
a winding pitch within a range of 0.5 mm to 5 mm;
opposite winding directions chosen from a lefthanded winding direction and a righthanded winding direction;
a shape bent in the same orientation with respect to the circumferential direction of the tire; and
essentially equal winding pitches.

8. The non-pneumatic tire, according to claim 1,
wherein each of the radially inner annular portion, the radially outer annular portion, and the plurality of spokes comprise one or more elastomer compositions,
wherein the one or more elastomer compositions of the radially inner annular portion, the radially outer annular portion, and each two circumferentially neighboring spokes of the plurality of spokes are reinforced and interconnected by said winding, and
wherein an elastomer composition of the radially inner annular portion is reinforced by the plurality of circumferentially extending cords.

9. The non-pneumatic tire according to claim 1,
wherein the radially inner annular portion comprises:
an annular connecting portion integrally formed with radially inner ends of the plurality of spokes and comprising radially inner portions of the winding; and
an annular band portion arranged radially inwards the connecting portion which comprises the plurality of circumferentially extending cords.

10. The non-pneumatic tire according to claim 1, wherein the tire comprises a circumferential tread band arranged on a radially outer side of the radially outer annular portion of the supporting structure, wherein the tread band comprises a radially outer circumferential tread portion and a circumferential shearband arranged radially between the tread portion and the radially outer annular portion of the supporting structure.

11. A non-pneumatic tire comprising a supporting structure comprising a radially inner annular portion, a radially outer annular portion and a plurality of spokes extending between the radially inner annular portion and the radially outer annular portion along a circumferential direction of the tire, wherein the radially inner annular portion has along the circumferential direction one or more of axially extending recesses and protrusions on its radially inner surface.

12. The non-pneumatic tire according to claim 11, wherein each of the one or more of axially extending recesses and protrusions has one or more of:
an axial extension of at most 80% of the maximum axial width of the tire;
a radial height within a range of 10% to 60% of the radial thickness of the radially inner annular portion;
a maximum circumferential width within a range of 5 mm to 5 cm; and
an axially inwards tapering shape.

13. A tire rim assembly comprising:
the tire according to claim 11, wherein the radially inner annular portion circumferentially surrounds one of an essentially cylindrical hollow space and a biconical hollow space; and
a rim insertable into the hollow space, wherein the rim comprises one or more of axially extending protrusions and recesses complementary to one or more of the axially extending recesses and protrusions of the tire to lock the tire against movement in the circumferential direction relative to the rim when the rim is inserted into the hollow space.

14. The tire rim assembly according to claim 13, wherein the rim comprises, on at least one of its lateral sides, a flange portion blocking movement of the radially inner annular portion in an axially outer direction.

15. The tire rim assembly according to claim 13, wherein the rim comprises two laterally opposite and circumferential flange portions, wherein at least one of the flange portions is detachably mountable with respect to another one of the flange portions to hold the tire between both flange portions against relative movement of the tire and the rim in an axial direction.

16. The tire rim assembly according to claim 13, wherein the rim comprises one or more of:
two laterally neighboring circumferential rim members axially insertable from two opposite lateral sides of the tire into the hollow space;
two laterally opposite circumferential flange portions; and
a radially inner hub portion with mounting holes, arranged along a circumferential direction, for receiving one or more of bolts and screws for mounting the rim to a vehicle.

17. The tire rim assembly according to claim 15, wherein the radially inner annular portion comprises axially extending and tapering recesses and the rim has axially extending and tapering protrusions axially insertable into the axially extending and tapering recesses of the radially inner annular portion.

18. The tire rim assembly according to claim 17, wherein the rim comprises a drum portion having a radially outer surface and two annular flange portions removably attachable to each lateral side of the drum portion, wherein each flange portion comprises the axially extending and tapering protrusions, which are arranged on the radially outer surface of the drum portion upon attachment of the flange portion to the drum portion.

19. The tire rim assembly according to claim 17, wherein the rim comprises a drum portion having a radially outer surface, wherein the drum portion comprises two axially adjacent drum portion members, wherein each of the two drum portion members comprises at one of its face sides one of the flange portions, and wherein each of the drum portion members is one or more of i) axially insertable into the hollow space of the tire from one lateral side of the tire, and ii) conically tapering from one lateral side towards an equatorial plane of the tire; and wherein both drum portion members are axially connectable to each other to axially hold the tire on the rim.

20. A non-pneumatic tire comprising a supporting structure comprising a radially inner annular portion, a radially outer annular portion and a plurality of spokes extending between the radially inner annular portion and the radially outer annular portion along a circumferential direction of the tire,
wherein each of the radially inner annular portion, the radially outer annular portion, and the plurality of spokes comprise one or more elastomer compositions,
wherein the one or more elastomer compositions of the radially inner annular portion, the radially outer annular portion, and the plurality of spokes are reinforced by cords,
wherein each of the spokes laterally extends along its entire radial height over at least 40% of the maximum axial width of the tire, and
wherein the spokes have from spoke to spoke, alternating angles with the axial direction along a circumferential direction of the tire.
